(19) United States
(12) Patent Application Publication
(10) Pub. No.: US 2009/0140533 A1
(43) Pub. Date: Jun. 4, 2009

(54) Detachable Magnetic Guard For Automobile Body Panels

(76) Inventors: Robert Frank Keough, Ypsilanti, MI (US); James Douglas Keough, North Wales, PA (US)

Correspondence Address: ROBERT FRANK KEOUGH, 5724 HAMPSHIRE LANE, YPSILANTI, MI, 48197, US

(21) Appl. No.: 11/949,025

(22) Filed: Dec. 1, 2007

(51) Int. Cl. B60R 19/22

(52) U.S. Cl. 293/109; 293/126

(57) ABSTRACT

A removable device magnetically attached to a vehicle exterior to guard against dings, dents and scuffs imposed by doors of adjacent vehicles in parking lot environments. The guard incorporates a vinyl covering for added durability and customization potential as well as beveled, ergonomic end caps for improved design aesthetics and efficient placement of the device on the vehicle body.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A SEQUENCE LISTING

Not Applicable

### BACKGROUND OF THE INVENTION

This invention relates to an automobile accessory designed to guard painted body sheetmetal surfaces from damage inflicted by adjacent vehicles' doors in parking lot environments. Such damage is often costly to repair and detracts from pride of ownership and resale value of the vehicle if left un-repaired. Three key trends contribute to an increased propensity for parking lot-induced dents, dings, scratches and other damage to automotive finishes and underlying sheetmetal. First, automobile manufacturers are marketing vehicles with doors that are longer and have greater “swing” in an effort to provide improved occupant ingress and egress. Second, many contemporary automobile designs feature clean, uncluttered styling executions. As a consequence, Original Equipment Manufacturer (OEM) body panel protection devices like door moldings or rub strips are frequently omitted from the vehicle design, or rendered ineffective due to insufficient size or poor placement. Finally, parking lot operators and retailers have a strong incentive to “stripe” parking lot spaces as narrowly as possible to accommodate the maximum number of vehicles within a fixed lot size.

It is therefore an objective of this invention to provide a removable body panel guard that is effective, ergonomic and aesthetic for use wherever a parked vehicle is susceptible to impacts from adjacent vehicles' doors, shopping carts and similar sources.

### SUMMARY OF THE INVENTION

The invention provides a lightweight, durable, non-marring guard detachably affixed to steel automobile body panels to minimize risk of damage caused by doors of adjacent vehicles being opened to the point of contact with the subject vehicle.

The device comprises a single resilient element suitably sized, shaped and constructed to absorb typical impact loads imparted to it without: 1) plastically deforming or 2) transferring sufficiently high forces to damage underlying painted body panels.

The guard is constructed by first bonding flexible magnetic strip to the flat surface of the resilient element, thereby allowing the guard to be removed from the vehicle when unneeded. Sheet vinyl is then applied to the resilient element/magnetic strip assembly for maximum durability and configurability of appearance. Ergonomic, stylized end caps are subsequently added to complete the assembly of the guard.

### BRIEF DESCRIPTION OF THE DRAWINGS

FIG. 1 is a partial side view of an automobile, illustrating a typical application of the invention to a vehicle door.

FIG. 2 is a perspective view of the assembled guard depicting the various components thereof.

FIG. 3 is a partial cross-sectional view of the guard taken along line 3-3 of FIG. 2.

FIG. 4 is a partial bottom view of the guard taken along line 4-4 of FIG. 2.

FIG. 5 is a cross-sectional view of the guard taken along line 5-5 of FIG. 2 to show end cap construction.

### DETAILED DESCRIPTION OF THE INVENTION

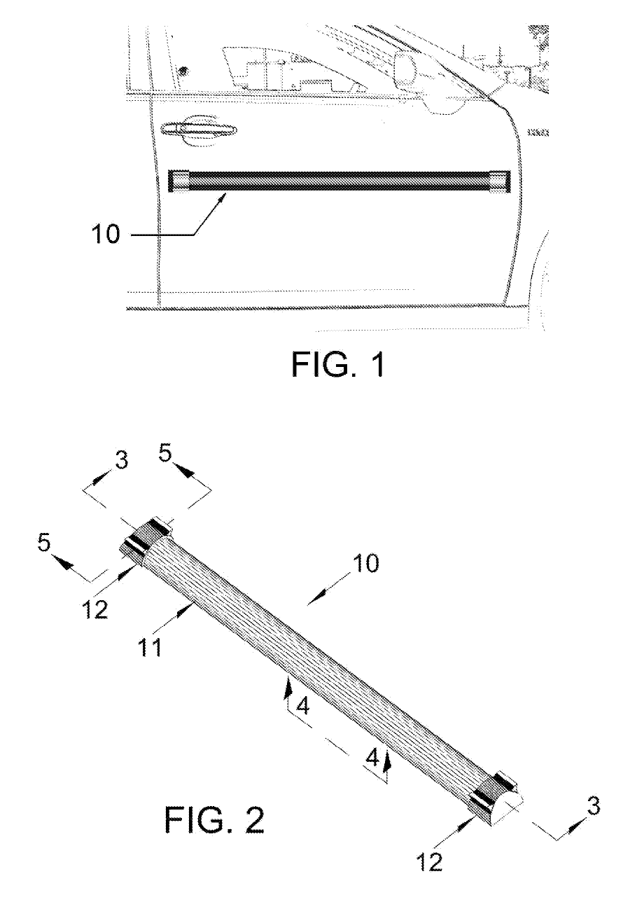

FIG. 1 shows the guard 10 detachably affixed to the door of a parked vehicle to protect the automobile from body damage caused by careless opening of an adjacent vehicle's doors. Guard 10 is positioned in a horizontal orientation on the vehicle body, at the vertical location coinciding with the greatest vehicle width, thereby affording maximum impact protection. Guard 10 is of sufficient length to span front door only, rear door only, or any combination of door(s), front fender and rear quarter panel. The length of each guard 10 is fixed and determined by a particular vehicle's dimensions.

Guard 10 is designed to visually integrate well with the vehicle, so as not to detract from the automobile's appearance and to discourage theft of the device. By making the guard 10 resemble an OEM-installed permanent molding, there is less likelihood that it will be stolen.

As shown in FIG. 2, the guard 10 comprises an absorber assembly 11 to which is attached an ergonomic, stylized end cap 12 at each end.

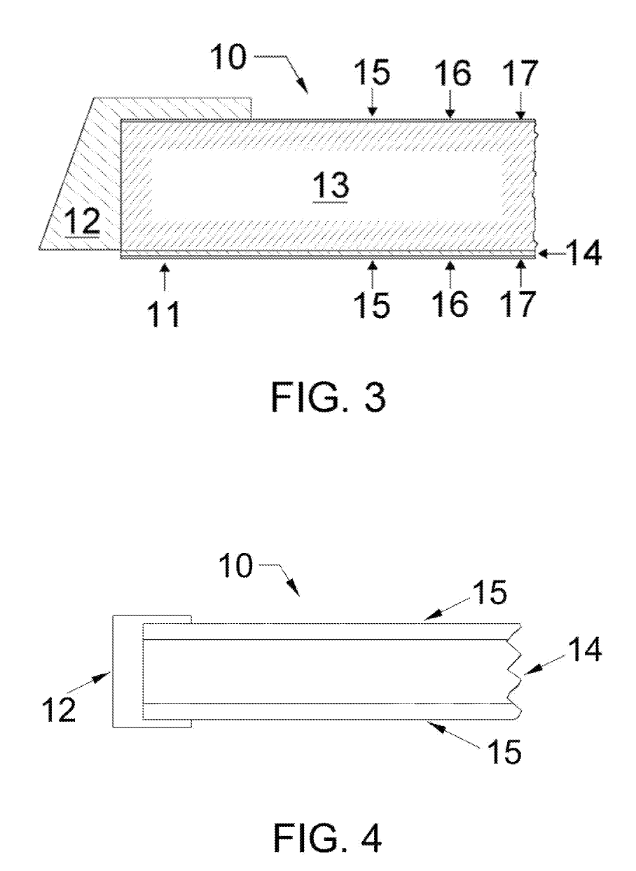

FIG. 3 describes construction of the absorber assembly 11. In the preferred embodiment, polyethylene foam 13 forms the core of the absorber assembly 11. Closed-cell polyethylene foam is used to prevent the guard 10 from absorbing water. Other materials with similar impact absorptive, shape recovery and waterproof properties, e.g., rubber, could be used in place of polyethylene foam. Flexible magnetic strip 14 is adhesively bonded to the base of the foam core 13, such that the magnetically attractive face of the strip 14 is oriented away from the foam core 13. Conventional sheet vinyl 15 or exterior-grade sheet vinyl for improved weather-ability and UV-resistance is adhesively attached over the foam core 13 and a portion of the magnetic strip 14. The sheet vinyl 15 can be selected from a wide array of colors and patterns to suit a vehicle owner's particular tastes.

In a second embodiment flexible, rubberized or otherwise elastomeric coating such as paint or liquid vinyl 16 is applied over the sheet vinyl 15 for added durability and an expanded range of color options.

In a third embodiment, the sheet vinyl 15 is replaced by a colored liquid elastomeric coating such as vinyl or rubber 17 applied to the foam core 13 to enhance durability and color availability.

An end cap 12 incorporating a beveled surface is adhesively attached to each end of the absorber assembly 11. The beveled surface functions to contribute to the aesthetics of the guard 10 and to allow the vehicle's doors to be opened without interference from the guard 10.

FIG. 4 illustrates how the sheet vinyl 15 wraps around to the underside of the guard, partially covering the magnetic strip 14. This design provides two benefits. First, the wrapped sheet vinyl 15 helps to secure the foam core 13 to the magnetic strip 14. Second, the wrapped sheet vinyl 15 functions to cover cut edges on the magnetic strip 14, thereby minimizing risk of damage to the vehicle's finish from installation and removal of the guard 10.

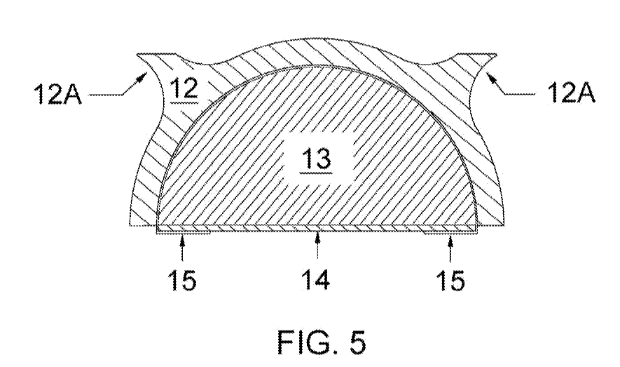

The cross-section of the end caps 12 is depicted in FIG. 5. Each end cap 12 incorporates symmetrical, ergonomic design features 12A to accommodate finger grip, thereby permitting the guard to be quickly and accurately positioned on the vehicle. The interior surface of the end cap 12 is shaped to be compatible with the outboard surface of the foam core 13 which is arcuate in shape. End caps 12 are to be injection molded or cast from plastic, rubber, vinyl or similar material that can be optionally colorized.

We claim:

1. A fixed-length removable guard for protecting automobile steel body panels, comprising:
an absorber assembly comprising:
a foam core bonded to flexible magnet and wrapped with sheet vinyl; and
a beveled end cap with ergonomic design features attached to each end.

2. The guard of claim 1 wherein a colored elastomeric coating is applied to the sheet vinyl.

3. The guard of claim 1 wherein the sheet vinyl is replaced by a liquid, colored elastomeric coating applied to the foam core.
